(19) United States
(12) Patent Application Publication
(10) Pub. No.: US 2026/0328195 A1
(43) Pub. Date: Oct. 22, 2026

(54) GRAVITY BASED ELECTRIC GENERATOR

(71) Applicants: Pranathi R Chituprolu, West Windsor Township, NJ (US); Sriya Gunti, West Windsor Township, NJ (US); Pranish Gunti, West Windsor Township, NJ (US)

(72) Inventors: Pranathi R Chituprolu, West Windsor Township, NJ (US); Sriya Gunti, West Windsor Township, NJ (US); Pranish Gunti, West Windsor Township, NJ (US)

(21) Appl. No.: 19/185,464

(22) Filed: Apr. 22, 2025

(51) Int. Cl. F03G 3/02

(52) U.S. Cl. CPC F03G 3/02; F05B 2210/11; F05B 2220/706; F05B 2260/4022; F05B 2260/4031

(57) ABSTRACT

A gravity-based electric generator has three primary system components which work in tandem to continually create electrical power by combining the effects of gravity with the characteristics of free standing fluid. The first component comprises gear wheels which engage a continuous, movable chain member. The second component comprises an actuator member aligned adjacent at its first end to the first component and is aligned adjacent to a second end to a third component. A third component comprises an elongated vertical tower extending upward from the second component. A plurality of spherical members are located along the first component, in the second component, and in the third component.

### FIELD OF THE INVENTION

The present invention relates to a gravity and liquid system to generate environmental friendly electrical power.

### BACKGROUND OF THE INVENTION

Various systems have been suggested for the generation of electricity using water containing vessels which are gravity operated. Examples of such systems are disclosed in U.S. Pat. Pub. 2007/0248339, U.S. Pat. Nos. 5,905,312, and 6,981,376. However, these and like systems, rely on unnecessary fluid transfers or other types of fluid movement and, importantly, require excessive energy utilization in comparison to the electrical energy actually produced.

### SUMMARY OF THE INVENTION

It is thus the object of the present invention to overcome the limitations and shortcomings of prior gravity based energy generating systems by providing a new and useful system which utilizes continually moving gravity controlled components in combination with a stationary, free standing fluid containing component.

This and other objects are accomplished by the present invention, a gravity based electric generator which comprises three primary system components which work in tandem to continually create electrical power by combining the effects of gravity with the characteristics of free standing fluid. The first component comprises gear wheels which engage a continuous, movable chain member. The second component comprises an actuator member aligned adjacent at its first end to the first component and is aligned adjacent to a second end to a third component. A third component comprises an elongated vertical tower extending upward from the second component. A plurality of spherical members are located along the first component, in the second component, and in the third component.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a perspective view of components of the present invention in its operational mode.

FIG. 2 is a perspective view of the outer body of the actuator member of the present invention.

FIG. 3 is a perspective view of the inner body of the actuator member of the present invention.

FIG. 4 is a perspective view of the piston, shaft, and motor of the present invention.

FIG. 5 is a partial sectional view of the metal spherical member of the present invention.

FIG. 6 is a view of the actuator member of the present invention in its initial, spherical member receiving mode.

FIG. 7 is a view of the actuator component of the present invention in its spherical member transmitting mode.

FIG. 8 illustrates the operation of the present invention, showing the inclusion of electronic generator drive wheels.

FIG. 9 showing the reverse side of the present invention illustrated in FIG. 8.

### DETAILED DESCRIPTION OF THE INVENTION

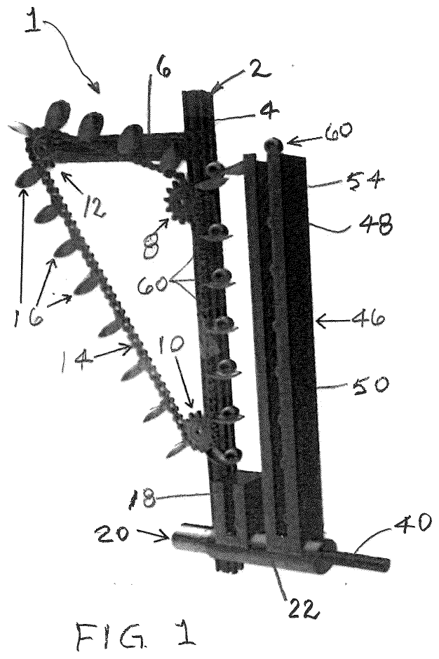

Gravity based generator 1 comprises three primary structural components. First component 2 comprises vertical stanchion 4 connected to horizontal arm 6. Gear wheels 8 and 10 are rotatably affixed to stanchion 45 and gear wheel 12 is rotatably affixed to arm 6. Continuous cycle chain 14 extends over and engages gear wheels 8, 10, and 12, as best seen in FIG. 1. A plurality of spherical member supporting cup shaped elements 16 are connected to chain 14 at spaced intervals. Stanchion 4 is connected and held in place at its lower end by stanchion support 18 which is open at its bottom.

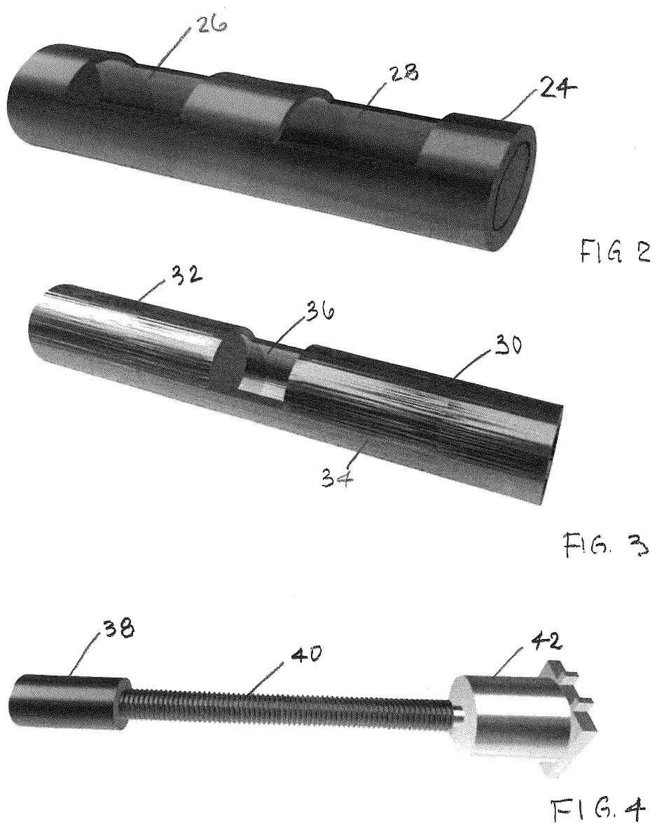

Second component 20 comprises actuator member 22 having outer body 24 shaped as a hollow, open tubular member having first cut-out opening 26 adjacent to and through one end and second cut-out opening 28 adjacent to and through the opposite end. See FIG. 2. Inner body 30 consists of two segments 32 and 34, with cut-out opening 36 therebetween. See FIG. 3. Segment 32 is open at its outboard end and closed at its inboard end. Inner body 30 is slidable within outer body 24.

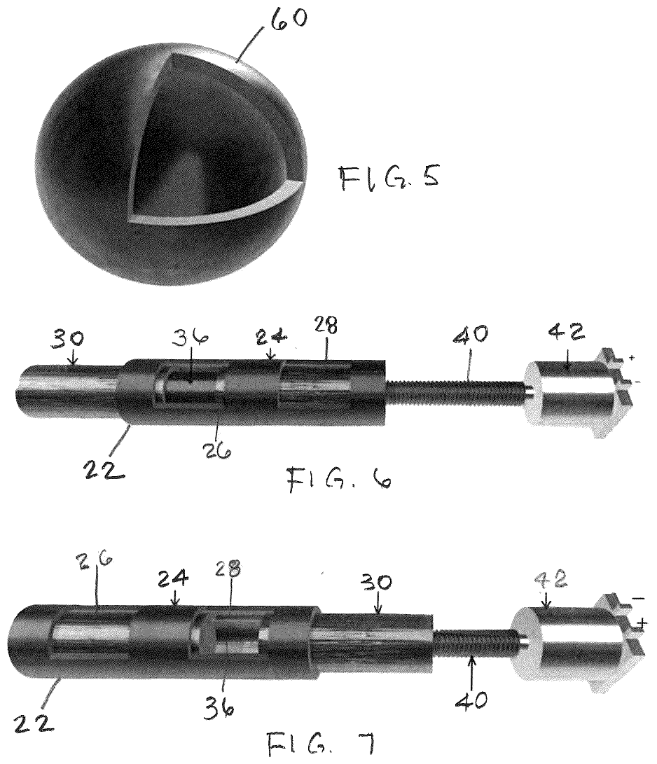

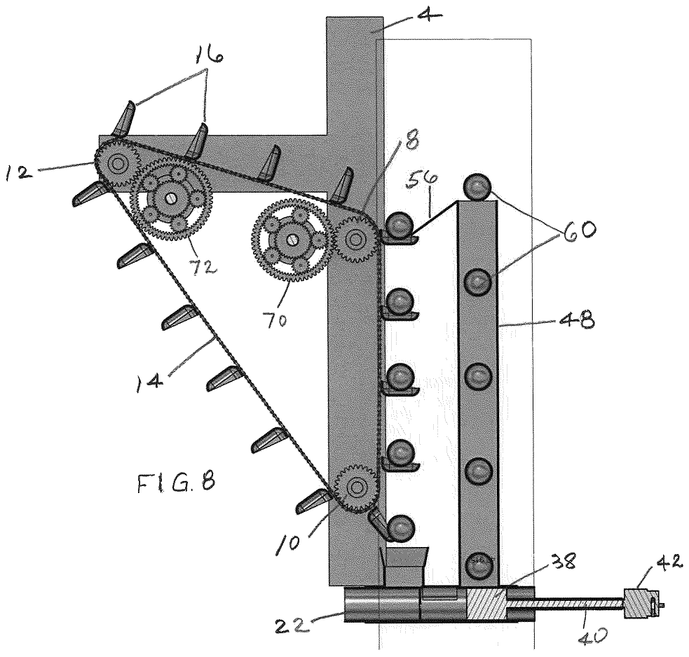

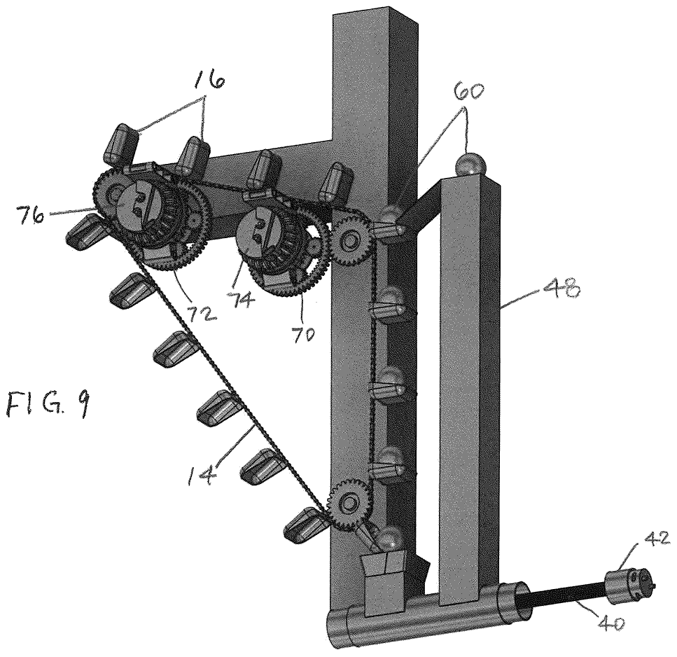

Piston 38 is connected by shaft 40 to DC motor 42. See FIG. 4. Piston 38 is slidably mounted within inner body 30 of actuator member 22. DC motor 42 connects DC power alternatively and can spin in clockwise and counterclockwise directions in frequent intervals. When rotating clockwise, piston 38 moves toward DC motor 42, which also moves inner body 30 towards the motor. When DC motor 42 rotates counterclockwise, piston 38 moves in the opposite direction, away from the motor, which also moves inner body 30 in that direction, away from the motor.

The bottom of stanchion support 18 is aligned over and open into first cut-out opening 26 of outer body 24. Liquid tower 48 of third component 46 is aligned over and opens into second cut-out opening 28 of the outer body. Stanchion support 18 is sealingly affixed to outer body 24 at first cut-out opening 26 and liquid tower 48 is sealingly affixed to the outer body at second cut-out opening 28.

Third component 46 comprises vertical liquid tower 48 having elongated channel 50 fitted with liquid 52. Tower cover 54 extends along and overlaying channel 50 to prevent fluid from exiting the channel. Liquid tower 48 is open at its bottom and thus opens into cut-out opening 28 and cut-opening 36 when this cut-out opening is below cut-out opening 28. Ramp 56 extends from the top of tower 48 to stanchion 4.

A plurality of spherical metal members 60 are integral components of the invention. Spherical members 60 each consist of a hollow metal sphere which is filled with air and sealed. See FIG. 5. Since they are made of metal, spherical members 60 are heavy enough to remain on cup elements 16, as the cup elements move upward on chain 14.

As spherical members 60 are hollow inside, they float, even when pushed to or near the bottom of a column of fluid. This is crucial in order to ensure that the spherical members are capable of rising from or near the bottom of liquid tower 48 to the top of the tower where the spherical members are transported to a cup element 16 via ramp 56.

During its operation, cycle chain 14, along with its attached cup elements 16, move in a clockwise direction around gear wheels 8, 10, and 12. Spherical members 60, one located on each of the cup elements 16, are moved towards the ground, one by one to be dropped into first cut-out opening 26 of outer body 24 and then through cut-out opening 36 of inner body 30, so that an individual spherical member 60 is located within actuator 22, as seen in FIG. 6.

DC motor 42 is operated to spin clockwise, thereby pulling both piston 38 and inner body 30 in which the piston is slidably located, towards the motor to a position in which spherical member 60 is moved from the location of first actuator cut-out 26 to the location of second actuator cut-out 28. This movement aligns cut-out 36 of inner body 30 with second cut-out 28 of outer body 24, as seen in FIG. 7. From this position, spherical member 60 enters water tower 48 and begins floating up to the top of the tower, where it is ultimately transported down ramp 56 onto a cup element 16. As spherical members 60 drop into cup elements 16 from ramp 56, the weight of the metal spherical member pushes cycle chain 14 towards the ground, which maintains the momentum in the system. This continued momentum ensures that chain 14 continues its movement around gear wheels 8, 10, and 12.

As a spherical member 60 enters liquid tower 48, DC motor operates in a counterclockwise direction, which serves to move piston 38 and inner body 30 away from the motor, ultimately to again align first cut-out opening 26 of outer body 24 with cut-out opening 36 of inner body 30, in order to receive the next spherical member 60 to be transported to liquid tower 48.

FIGS. 8 and 9 show the gearing scheme, in which continually rotating gear wheels 8 and 12 engaging generator drive gears 70 and 72. Gears 70 and 72 are attached to couplings 74 and 76 which are connected to drive electric generators. It is contemplated that two electric generators will be attached via gears 70 and 72. These electrical generators are equipped with gearboxes which rotate an electric generator shaft. The speed of the gear wheels to generators have a 1:10 ratio.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A gravity-based electric generator comprising:
a first component having gear wheels which engage a continuous, movable chain member;
a second component comprising an actuator member aligned adjacent at its first end to the first component and aligned adjacent at its second end to a third component;
said third component comprising an elongated, vertical tower extending upward from the second component;
and a plurality of spherical members located along the first component, in the second component, and in the third component.

2. The gravity based electric generator as in claim 1 wherein the actuator member comprises an outer body with a first cut-out opening through said first end, said opening being aligned with the first component, and a second cut-out opening through said second end, said opening being aligned with the third component.

3. The gravity based electric generator as in claim 1 wherein the outer body is hollow and houses an inner body having a cut-out opening.

4. The gravity based electric generator as in claim 3 wherein the outer body comprises a first cut-out opening through said first end, said opening being aligned with the first component, and a second cut-out opening through said second end, said opening being aligned with the third component.

5. The gravity based electric generator as in claim 1 further comprising an electric motor connected by a shaft to a piston.

6. The gravity based electric generator as in claim 5 wherein the actuator member is hollow and houses an inner member and wherein the piston is configured to move laterally within the actuator and in contact with the inner member.

7. The gravity based electric generator as in claim 1 wherein the third component comprises an elongated channel containing a liquid.

8. The gravity based electric generator as in claim 6 wherein the third component comprises an elongated channel containing a liquid.

9. The gravity based generator as in claim 8 further comprising a plurality of spherical member supporting cup elements connected to the chain member at spaced intervals, said spherical members being positioned on the cup elements.

10. The gravity based electric generator as in claim 1 wherein at least one of the gear wheels is linked to an electric generator and upon movement of the chain member around the gear wheels, the spherical members travel from the first component to the second component, then to the third component, and then return to the first component, thereby creating rotational energy which is transmitted in order to power the electric generator.

11. The gravity based electric generator as in claim 9 wherein at least one of the gear wheels is linked to an electric generator and upon movement of the chain member around the gear wheels, spherical members positioned on the cup elements travel down and are dropped into the actuator, are compelled by the piston through the actuator, enter the channel of the tower and travel up through the liquid in the channel, and are then returned to the first component, thereby creating rotational energy which is transmitted in order to power of the electric generator.
